(19) United States
(12) Patent Application Publication
(10) Pub. No.: US 2008/0128147 A1
(43) Pub. Date: Jun. 5, 2008

(54) Ground cultivation tool

(76) Inventor: Kenneth E. Lynch, Dunlap, IL (US)

Correspondence Address: BOWMAN & ASSOCIATES, 1016 3rd Avenue, SW, Suite #106, CARMEL, IN, 46032, US

(21) Appl. No.: 12/011,728

(22) Filed: Jan. 29, 2008

Related U.S. Application Data
(63) Continuation-in-part of application No. 11/511,971, filed on Aug. 29, 2006.

(51) Int. Cl. A01B 33/02

(52) U.S. Cl. 172/349

(57) ABSTRACT

A manually operated ground cultivation tool is characterized by a roller assembly formed of one or more assemblages of a plurality of stacked disks that are each independently rotatably supported on a central axle. Each disk carries a plurality of radially extending tines. Each axle is supported by a yoke assembly that is attached to a shaft/handle structure. Each disk includes slots that are configured to accept nails as the radially extending tines. The disks accept different length nails in order to vary ground depth penetration as desired. The disks are preferably formed of a suitable plastic and as such, may be injection molded.

### RELATED APPLICATIONS

This patent application is a continuation-in-part of pending U.S. patent application Ser. No. 11/511,971 filed Aug. 29, 2006, entitled “Ground Cultivation Tool”.

### BACKGROUND OF THE INVENTION

1. Field of the Invention

The present invention relates to manually operated tools for preparing soil.

2. Background Information

There are many instances where the ground must first be prepared before continuing with a project. This is especially true when planting grass seed, planting flower or other seeds, or when weeding and/or planting a vegetable garden. When sowing planting grass seed, for instance, it is essential for best results to loosen or prepare the soil before spreading the grass seed. Conventionally, tools such as hoes, shovels, rakes, forks, claws and/or spades may be used to loosen or prepare the soil for planting. While power machinery such as tillers and the like may be used for soil preparation, the expense and bother of such power machinery typically does not justify their use. Moreover, lack of storage space for and/or frequency of use of such power machinery makes ownership and thus use thereof atypical for the average person.

Various implements have therefore been devised for manually preparing the soil for planting and/or the like. For instance, U.S. Pat. Nos. 1,014,045 and 2,022,335 each teach a hand tool for loosening, cutting and/or crumbling soil each one of which is characterized by a plurality of pronged tools or flat metal disks that are carried on a rotatable axle. U.S. Pat. Nos. 1,305,215, 2,748,683 and 2,975,735 all teach a tool for conditioning soil, each one of which is characterized by a drum or cylinder that is rotatably carried on an axle that is supported on a yoke. The rotatable cylinder includes a plurality of tines, prongs or spikes that radially extend from the rotating cylinder. Further, U.S. Pat. Nos. 3,605,907 and 4,678,043 each teach a hand tool for loosening soil each one having a central axle that carries a plurality of pairs of pronged wheel arrangements having radially extending prongs. The pronged wheel arrangements are also freely rotatably mounted on the axle and such that vertical central planes of the pronged wheels extending in the direction of extension of the radial prongs, intersect one another at an acute angle.

Moreover, U.S. Pat. No. 2,188,644 teaches a manually operated cultivator characterized by a cylinder formed of plurality of flat, circular metal disks. Every other disk includes a plurality of teeth or spikes that are fixedly cast within the metal composing the disk. The teeth or spikes have shanks that are bent at an obtuse angle to form soil penetrating prongs. The cylinder is a solid unit with the teeth on one disk retained in staggered relation with the teeth on the adjacent disk.

While the above cited patents all teach various types of manually operated soil conditioners, such manually operated tools are awkward, heavy and/or cumbersome to use. Moreover, soil preparation with such prior art tools is still an exhausting activity. Still further, such prior art soil preparation tools are inflexible in modification such as being able to change the length and/or type of tines utilized.

In view of the foregoing, it would be an advance in the art to provide a ground cultivation tool that makes the task of manually conditioning the soil easier.

### SUMMARY OF THE INVENTION

The present invention is a ground or soil conditioning tool characterized by one or more roller assemblies each formed of a plurality of stacked disks of which each is independently rotatably supported on a central axle. A first face of each disk has an annular groove surrounding an axle bore thereof and a plurality of spaced, radial grooves extending from the annular groove. The annular groove is configured to receive a head of a nail while the shank of each nail is situated in a radial groove. In this manner, each disk carries a plurality of radially extending tines that are retained by adjacent disks. A second face of each disk includes an annular groove surrounding the axle bore and is adapted to receive a head of a nail of an adjacent disk when disks are stacked to form a tined roller assembly. Since the nails are releasably retained by the disks, roller assemblies having disks with different length nails may be used in order to vary ground depth penetration as desired.

The axle and thus the tined roller assembly of each one of the present soil preparation tools are supported by a yoke that is attached to a shaft and handle structure. The shaft may be formed of a single piece or multiple pieces. In the case of multiple pieces, the shaft may be sized for hand use or upright use. A bent neck connecting the shaft to the yoke allows pressure exerted on the handle to be applied downwardly onto the roller assembly.

In one form, the present invention provides a soil preparation tool having a handle, a shaft having a distal end connected to the handle and a proximate end having a downward curve, a yoke having a neck connected to the proximal end of the shaft and first and second arms extending from the neck and spaced a width from each other, the first and second arms each having an axle bore at proximal ends thereof, an axle supported in the axle bores of the first and second arms, and a roller assembly disposed on the axle, the roller assembly having a plurality of disks each one of which has a plurality of radially extending tines and independently rotatably carried on the axle.

In another form, the present invention provides a soil preparation tool having a handle, a shaft having a distal end connected to the handle and a proximate end having a downward curve, a yoke having a neck connected to the proximal end of the shaft and first and second arms extending from the neck and spaced a width from each other, the first and second arms each pivotally connected to a cross-bar supporting two rotatable roller assemblies each formed of a plurality of disks each disk of which has a plurality of radially extending tines and independently rotatably carried on an axle thereof. The cross bars each include two axle bores supporting an axle of the roller assembly within an axle bore thereof.

The present soil preparation tool may be used to cultivate bare spots in a lawn in order to prepare the soil for grass seeding. The soil preparation tool may also be used to cultivate the soil in a garden or for landscaping around plantings. When rolled back and forth, the tines chew and thereby loosen the soil. In the case of preparation of the soil for grass seeding, once the grass seed has been sown, rolling the present soil preparation tool back over the seeded area works the seeds into the soil.

### BRIEF DESCRIPTION OF THE DRAWINGS

The above mentioned and other features, advantages and objects of this invention, and the manner of attaining them, will become apparent and the invention itself will be better understood by reference to the following description of embodiments of the invention taken in conjunction with the accompanying drawings, wherein:

FIG. 1 is a perspective view of an exemplary embodiment of a ground cultivation tool fashioned in accordance with the principles of the present invention;

FIG. 2 is an enlarged perspective view of the roller assembly of the present ground cultivation tool;

FIG. 3 is an enlarged perspective view of one side of a disk of the roller assembly of the present ground cultivation tool;

FIG. 4 is an enlarged perspective view of another side of the disk of the roller assembly of the present ground cultivation tool;

FIG. 5 is an enlarged perspective view of the disk of the roller assembly of the present ground cultivation tool illustrating the manner in which tines thereof are received by the disk;

FIG. 6 is an enlarged perspective view of another embodiment of a ground cultivation tool fashioned in accordance with the principles of the present invention;

FIG. 7 is an enlarged perspective view of a roller and yoke assembly of another embodiment of a ground cultivation tool fashioned in accordance with the principles of the present invention;

FIG. 8 is a perspective view of another embodiment of a ground cultivation tool fashioned in accordance with the principles of the present invention; and

FIG. 9 is an enlarged perspective view of the roller assembly of the ground cultivation tool of FIG. 8.

Like reference numerals indicate the same or similar parts throughout the several figures.

A discussion of the features, functions and/or configuration of the components depicted in the various figures will now be presented. It should be appreciated that not all of the features of the components of the figures are necessarily described. Some of these non-discussed features as well as discussed features are inherent from the figures. Other non discussed features may be inherent in component geometry and/or configuration.

### DETAILED DESCRIPTION OF EMBODIMENTS OF THE INVENTION

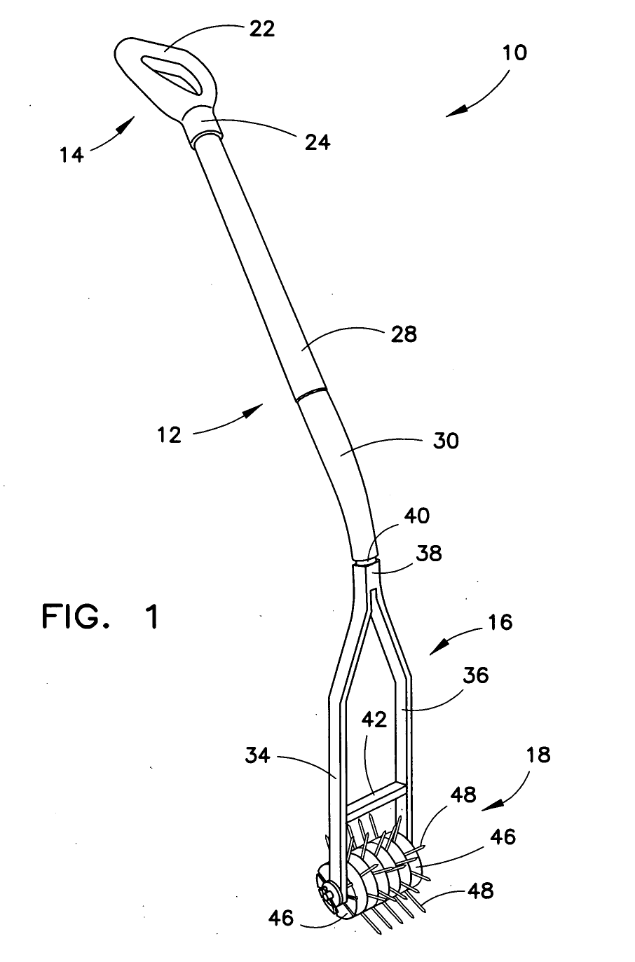

Referring to the Figures and in particular to FIG. 1, there is shown a ground cultivation tool generally designated 10 fashioned in accordance with the principles of the present invention. The ground cultivation tool 10 is a manually operated tool used to loosen, cut, crumble and/or prepare soil or ground especially in preparation of planting seed such as grass seed. The ground cultivation tool 10 is characterized by a shaft portion or assembly 12, a handle portion or assembly 14, a yoke portion or assembly 16 and a roller or ground cultivation portion or assembly 18.

The shaft portion 12 of the ground cultivation tool 10 is defined by a shaft 28 and a neck 30. The shaft 28 is preferably, but not necessarily, straight. The neck 30 is curved or bent downwardly relative to the shaft 28 so as to allow the user to direct pressure applied to the handle and or shaft of the tool 10 directly down on the roller assembly 18 when in use. The shaft portion 12 is preferably, but not necessarily, formed of a suitable material such as metal, plastic, fiberglass, carbon fiber or the like. The shaft 28 and neck 30 may or may not be formed as one piece. Likewise, rather than being a single piece of shaft, the shaft 28 itself may consist of a plurality of shafts that can be assembled (and disassembled) in order to allow variation in the length of the shaft 28. This allows the cultivation tool 10 to accommodate users of various heights.

The handle section 14 of the ground cultivation tool 10 is disposed on the distal end of the shaft 28. The handle section 14 includes a handle 22 formed of a suitable material such as plastic or metal and configured in a fashion typical for tool handles. The handle 22 includes a collar 24 that is configured to receive the distal end of the shaft 28. Of course, other handle configurations may be used and are contemplated.

The yoke section 16 is attached to the proximal end of the shaft portion 12 and, particularly, is connected to the neck 30 of the shaft portion 12. The yoke section 16 carries the roller assembly 18 and is defined by a first arm 34 and a second arm 36 each of which extends angularly from a stem 38. The first and second arms 34, 36 and the stem 38 essentially form a “Y”. A foot bar 42 is disposed transversely between the first and second arms 34, 36. The foot bar 42 is spaced a distance from the stem 38 so as to allow a user's foot (and shoe) to be placed between the first and second arms 34, 36 and onto the foot bar 42. This allows the user to apply downward pressure on the yoke assembly 16 and particularly the roller assembly 18 during use, if necessary. The yoke assembly 16 is formed of a suitable material such as metal, plastic, fiberglass, carbon fiber or the like.

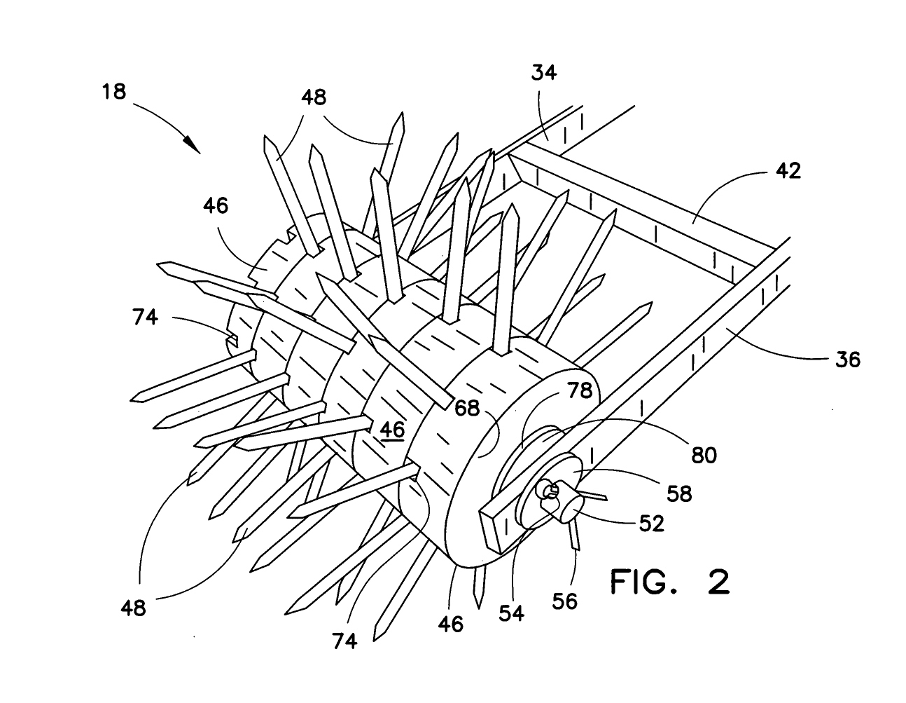

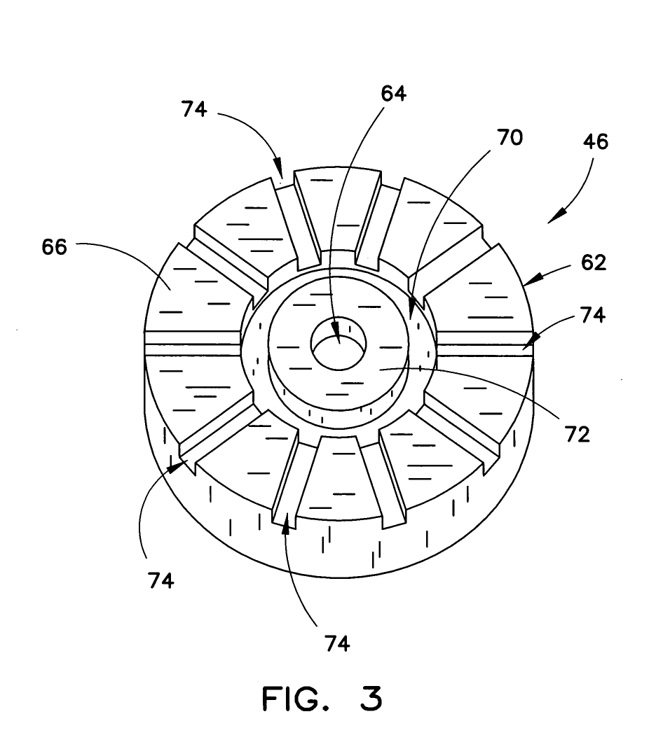

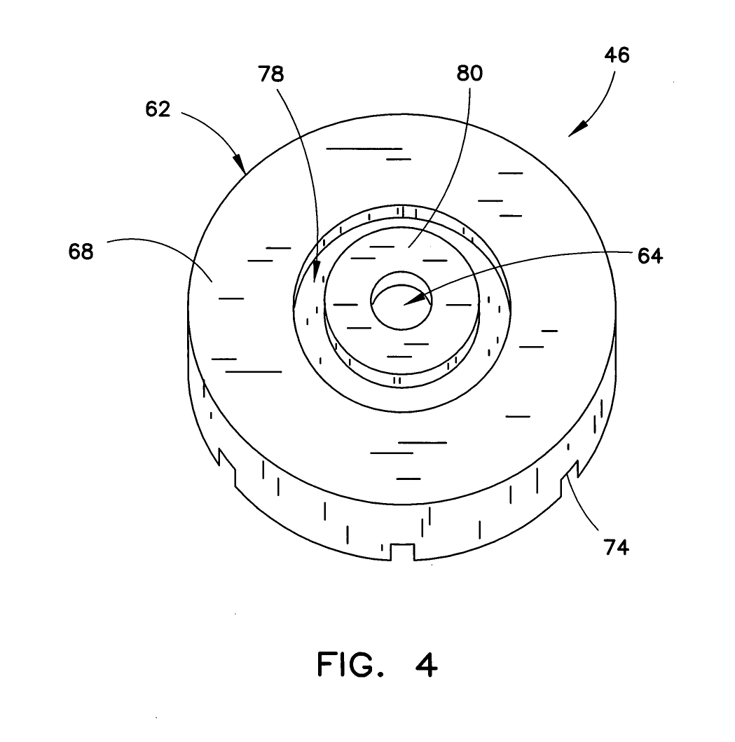

With additional reference to FIG. 2, the roller assembly 18 is formed of a plurality of identical disks 46, each one of which carries a plurality of radially extending tines or spikes 48. The tines 48 are removably retained in the disk 46. As best depicted in FIGS. 3 and 4, each disk 46 (and only one such disk 46 is shown) is characterized by an annular body 62 that defines a first surface or face 66 and a second, oppositely disposed surface or face 68. A central bore 64 is formed in the body 62. In accordance with an aspect of the present invention, the first surface has an annular groove or channel 70 that is situated about the central bore 64 and thus forms an annular land portion or hub 72 between the central bore 64 and the annular groove 70. The first surface further includes a plurality of radially extending grooves or channels 74 that emanate from the annular groove 70. The radially extending grooves 74 are preferably, but not necessarily, spaced evenly about the central bore. It should be appreciated, that while ten (10) radial grooves 74 are shown, the disk 46 may have more or less radial grooves. Moreover, while each disk 46 of the roller assembly 18 has the same number of radial grooves 74, a roller assembly may consist of disks having a different number of radial grooves.

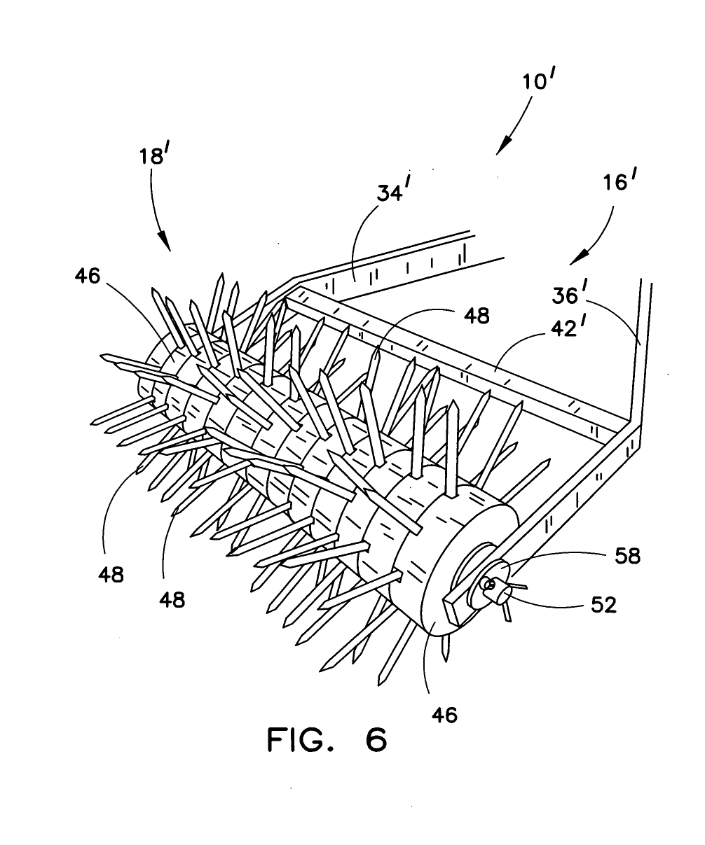

The second surface or face 68, as seen in FIG. 4, includes an annular groove 78 that is situated about the central bore 64 and thus forms an annular land portion or hub 80. The second surface 68 of one disk 46 is adapted to abut the first surface 66 of an adjacent disk 46 when the disks are assembled into a roller assembly. When so assembled, the head of a nail or tine carried by one disk is received in the annular groove 78 of an adjacent disk 46. Additionally, as best seen in FIG. 2, a disk 46 without tines therein may be used as an end disk (to the left side as seen in FIG. 2) of the roller assembly 18 without having to manufacture and use another configuration of a disk that has one face with no grooves and another face with only an annular groove about its center bore. However, this is contemplated as shown in roller assembly 18′ of the ground cultivation tool 10′ as shown in FIG. 6.

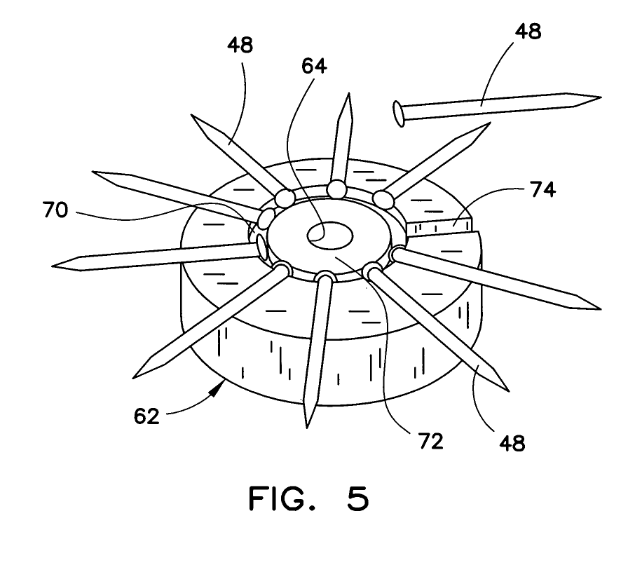

As illustrated in FIG. 5, the radial grooves 74 are sized to receive and hold tines 48 therein. The tines are preferably, but not necessarily nails such as masonry nails, but may be other types of nails or the like. As nails, the head of the nail is received in the annular groove 70 while the shaft of the nail is received in a radial groove. The length of the nail (tine) determines the penetration depth of the roller assembly 18. It is preferable, but not necessary, that the tines 48 be of the same length. A disk may have tines of different lengths if desired.

In a preferred form, a disk 46 is formed of plastic and is injection molded. Each disk 46 has a diameter of 2½ inches with a ¾ inch thickness. As such, the roller assembly 18 of FIG. 1 has a length of approximately four (4) inches while the roller assembly of FIG. 6 has a length of approximately ten (10) inches. Of course, disks may have other dimensions.

As best seen in FIG. 2, the roller assembly 18 of the ground cultivation tool 10 includes an axle or shaft 52 that extends through bores in the ends of the first and second arms 34, 36 and the central bores 64 of each disk 46. A washer 58 is preferably provided adjacent the axle bores of each arm 34, 36. The axle 52 has a bore 54 on both ends thereof (of which only one end can be seen in FIG. 2) that extends transverse to the longitudinal axis of the axle 52. A cotter pin 56 or the like is disposed in each axle bore 54 in order to retain the roller assembly 18 onto the yoke assembly 16. Each disk 46 is free to rotate about the shaft 52 independently of one another. The axle 52 may or may not be rotatable.

Referring now to FIG. 6, there is depicted an embodiment of a ground cultivation tool 10′ having a roller assembly 18′ with twelve (12) tined disks and an end cap disk. The yoke assembly 16′ includes a first arm 34′ and a second arm 36′ that are spaced further apart than the arms 34, 36 of the ground cultivation tool 10 in order to accommodate the longer roller assembly 18′. As such, the foot bar 42′ is longer to span the wider width thereof. It should thus be appreciated that the present ground cultivation tool may have any number of disks.

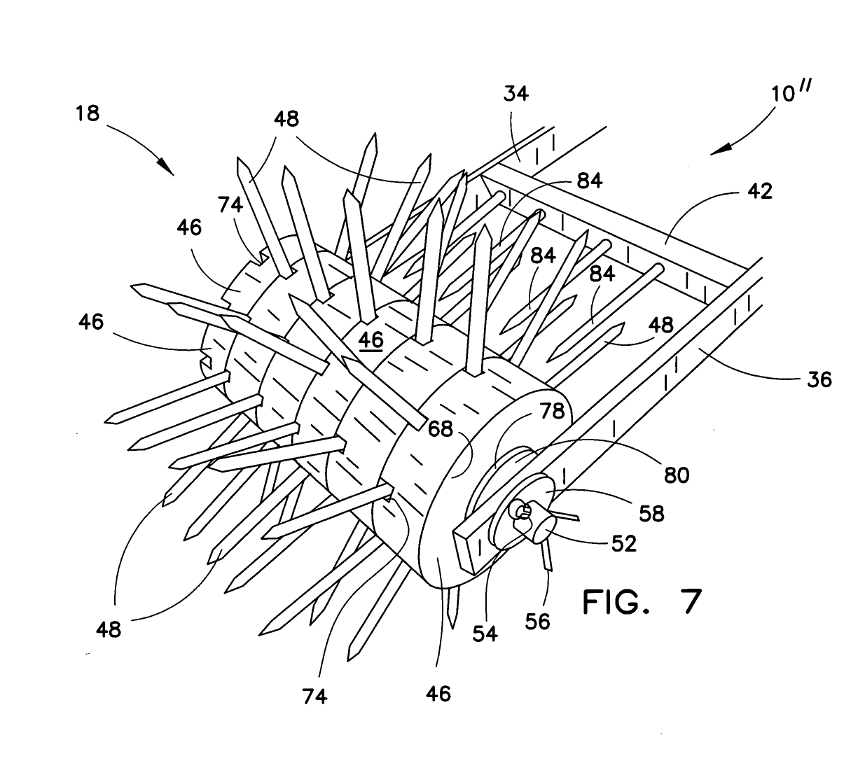

Referring to FIG. 7, there is shown another embodiment of a ground cultivation tool 10″ in which the foot bar 42 thereof has tines or spikes 84 extending toward the roller assembly 18. The tines 84 are spaced at intervals along the foot bar 42 such that the tines 84 are between the tines 48 of the disks 46. The foot bar tines 84 clean leaves, dirt and debris that may accumulate on the roller assembly 18.

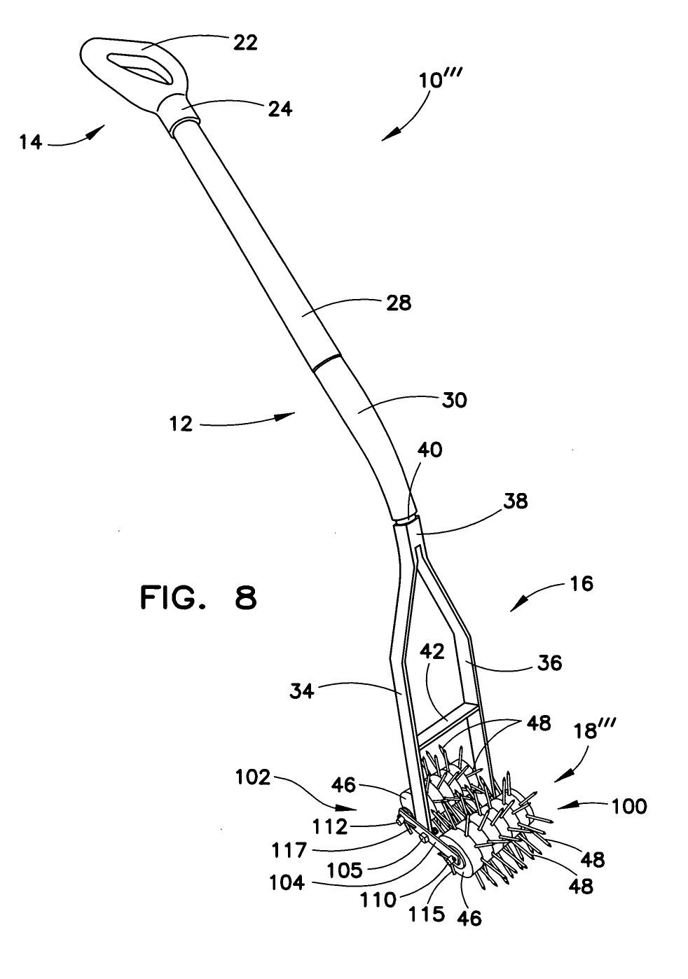

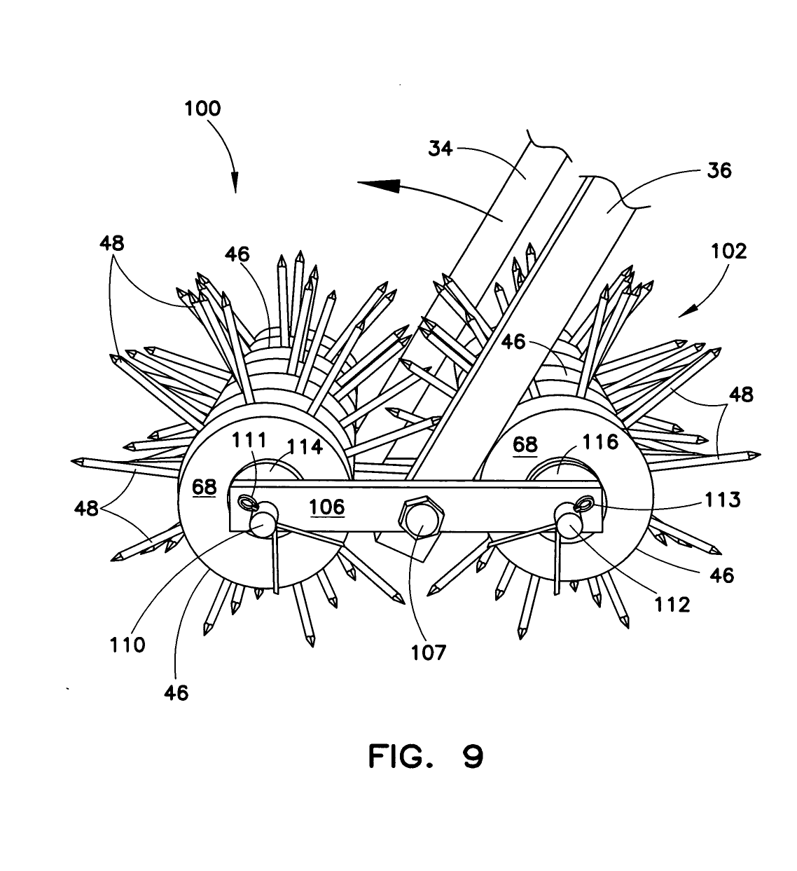

Referring to FIGS. 8 and 9, there is shown yet another embodiment of a ground cultivation tool 10′″. The ground cultivation tool 10′″, in like manner to the ground cultivations tools 10′ and 10″, has the shaft portion or assembly 12, the handle portion or assembly 14 and the yoke portion or assembly 16. The shaft portion 12 of the ground cultivation tool 10′″ is defined by the shaft 28 and the neck 30. The shaft 28 is preferably, but not necessarily, straight. The neck 30 is curved or bent downwardly relative to the shaft 28 so as to allow the user to direct pressure applied to the handle and or shaft of the ground cultivation tool 10′″ directly downward when in use. The shaft portion 12 is preferably, but not necessarily, formed of a suitable material such as metal, plastic, fiberglass, carbon fiber or the like. The shaft 28 and neck 30 may or may not be formed as one piece. Likewise, rather than being a single piece of shaft, the shaft 28 itself may consist of a plurality of shafts that can be assembled (and disassembled) in order to allow variation in the length of the shaft 28. This allows the cultivation tool 10 to accommodate users of various heights.

The handle section 14 of the ground cultivation tool 10′″ is disposed on the distal end of the shaft 28. The handle section 14 includes the handle 22 formed of a suitable material such as plastic or metal and configured in a fashion typical for tool handles. The handle 22 includes the collar 24 that is configured to receive the distal end of the shaft 28. Of course, other handle configurations may be used and are contemplated.

The yoke section 16 is attached to the proximal end of the shaft portion 12 and, particularly, is connected to the neck 30 of the shaft portion 12. The yoke section 16 carries a roller assemblage 18′″ and is defined by the first arm 34 and the second arm 36 each of which extends angularly from the stem 38. The first and second arms 34, 36 and the stem 38 essentially form a “Y”. The foot bar 42 is disposed transversely between the first and second arms 34, 36. The foot bar 42 is spaced a distance from the stem 38 so as to allow a user's foot (and shoe) to be placed between the first and second arms 34, 36 and onto the foot bar 42. This allows the user to apply downward pressure on the yoke assembly 16 and particularly the roller assemblage 18′″ during use, if necessary. The yoke assembly 16 is formed of a suitable material such as metal, plastic, fiberglass, carbon fiber or the like.

The roller assemblage 18′″ has two roller assemblies 100 and 102 connected to the yoke section 16 via a first sidebar or crossbar 104 and a second sidebar or crossbar 106. The first crossbar 104 is pivotally coupled to the first arm 34 via a fastener 105 (such as a bolt) while the second crossbar 106 is pivotally coupled to the second arm 36 via fastener 107 (such as a bolt). This allows the first and second crossbars 34, 36 to pivot relative to the first and second arms 34, 36 (or vice versa) as represented by the arrow in FIG. 9. The first and second roller assemblies 100, 102 are each independently rotatable relative to the first and second crossbars 104, 106.

A first axle or shaft 110 extends through bores in the front ends of the first and second arms 34, 36 and the central bores 64 of each disk 46 of the first roller assembly 100. A washer is preferably provided adjacent the front axle bores of each arm 34, 36, the washer 114 of which is seen in FIG. 9. The axle 110 has a bore on both ends thereof that extends transverse to the longitudinal axis of the axle 110. A cotter pin 111 or the like is disposed in the transverse bore of the axle 110 proximate the second crossbar 106 while a cotter pin 115 or the like is disposed in the transverse bore of the axle 110 proximate the first crossbar 104 in order to retain the first or front roller assembly 100 onto the yoke assembly 16. Each disk 46 thereof is free to rotate about the axle 110 independently of one another. The axle 110 may or may not be rotatable.

A second axle or shaft 112 extends through bores in the rear ends of the first and second arms 34, 36 and the central bores 64 of each disk 46 of the second roller assembly 102. A washer is preferably provided adjacent the rear axle bores of each arm 34, 36, the washer 116 of which is seen in FIG. 9. The axle 112 has a bore on both ends thereof that extends transverse to the longitudinal axis of the axle 112. A cotter pin 113 or the like is disposed in the transverse bore of the axle 112 proximate the second crossbar 106 while a cotter pin 117 or the like is disposed in the transverse bore of the axle 112 proximate the first crossbar 104 in order to retain the second or rear roller assembly 102 onto the yoke assembly 16. Each disk 46 thereof is free to rotate about the axle 112 independently of one another. The axle 112 may or may not be rotatable.

It can be appreciated that as the roller assemblies 100 and 102 rotate, the tines 46 of the each roller assembly mesh at an area between the roller assemblies 100, 102 (i.e. adjacent the pivot point between the first and second arms 34, 36 and the first and second crossbars 104, 106, the pivot point defined by the first and second fasteners 105, 107). This occurs whether the tool 10′″ is moved in a forward direction or in a backward direction. As the tines 46 of one roller assembly 100 or 102 moves in a clockwise direction (depending on whether the ground cultivation tool 10′″ is moved in a forward or a backward direction), the tines 46 of the other of the roller assemblies 100 or 102 moves in a counterclockwise direction (again depending on whether the ground cultivation tool 10′″ is moved in a forward or backward direction). This creates a meshing of the tines moving in opposite rotational directions providing a self cleaning action of the tines 46 and thus of the roller assemblies 100, 102.

While the invention has been illustrated and described in detail in the drawings and foregoing description, the same is to be considered as illustrative and not restrictive in character, it being understood that only preferred embodiments have been shown and described and that all changes and modifications that come within the spirit of the invention are desired to be protected.

What is claimed is:

1. A soil preparation tool comprising:
a handle;
a shaft having a distal end connected to the handle and a proximate end having a downward curve;
a yoke having a neck connected to the proximal end of the shaft and first and second arms extending from the neck and spaced a width from each other, the first arm having a first connection bore at a proximal end thereof, and the second arm having a second connection bore at a proximal end thereof;
a first crossbar connected to the first arm via the first connection bore, the first crossbar having a first front axle bore and a first rear axle bore;
a second crossbar connected to the second arm via the second connection bore, the second crossbar having a second front axle bore and a second rear axle bore;
a first axle supported in the first and second front axle bores of the first and second crossbars;
a first roller assembly disposed on the first axle, the first roller assembly having a plurality of disks each one of which has a plurality of radially extending tines and independently rotatably carried on the first axle;
a second axle supported in the first and second rear axle bores of the first and second crossbars; and
a second roller assembly disposed on the second axle, the second roller assembly having a plurality of disks each one of which has a plurality of radially extending tines and independently rotatably carried on the second axle.

2. The soil preparation tool of claim 1, wherein the first crossbar is pivotally connected to the first arm and the second crossbar is pivotally connected to the second arm.

3. The soil preparation tool of claim 1, wherein the disks are formed of plastic.

4. The soil preparation tool of claim 3, wherein the disks are injection molded.

5. The soil preparation tool of claim 1, further comprising a foot bar extending between the first and second arms distal the first and second roller assemblies.

6. The soil preparation tool of claim 5, wherein the foot bar includes a plurality of spikes extending towards the roller assembly.

7. The soil preparation tool of claim 1, wherein the plurality of tines of each disk is retained in grooves disposed in a first side of the disk.

8. The soil preparation tool of claim 7, wherein the tines are releasably retained in the grooves.

9. A soil preparation tool comprising:
a handle;
a shaft having a distal end connected to the handle and a proximate end having a downward curve;
a yoke having a neck connected to the proximal end of the shaft and first and second arms extending from the neck and spaced a width from each other, the first arm having a first connection bore at a proximal end thereof, and the second arm having a second connection bore at a proximal end thereof;
a first crossbar connected to the first arm via the first connection bore, the first crossbar having a first front axle bore and a first rear axle bore;
a second crossbar connected to the second arm via the second connection bore, the second crossbar having a second front axle bore and a second rear axle bore;
a first axle supported in the first and second front axle bores of the first and second crossbars;
a first plurality of disks stacked adjacent one another and each independently rotatably supported on the first axle, each disk having a first side with a first annular groove and a plurality of spaced, radial grooves extending from the annular groove, and a second face having a second annular groove with a plurality of nails carried by each disk, each one of the plurality of nails having a shank disposed in one of the radial grooves of the disk and a head disposed in the first annular groove;
a second axle supported in the first and second rear axle bores of the first and second crossbars; and
a second plurality of disks stacked adjacent one another and each independently rotatably supported on the second axle, each disk having a first side with a first annular groove and a plurality of spaced, radial grooves extending from the annular groove, and a second face having a second annular groove with a plurality of nails carried by each disk, each one of the plurality of nails having a shank disposed in one of the radial grooves of the disk and a head disposed in the first annular groove;
wherein the heads of the nails carried by one disk is received in the second annular groove of an adjacent stacked disk.

10. The soil preparation tool of claim 9, wherein the first crossbar is pivotally connected to the first arm and the second crossbar is pivotally connected to the second arm.

11. The soil preparation tool of claim 9, wherein the disks are formed of plastic.

12. The soil preparation tool of claim 11, wherein the disks are injection molded.

13. The soil preparation tool of claim 9, further comprising a foot bar extending between the first and second arms distal the plurality of disks.

14. The soil preparation tool of claim 13, wherein the foot bar includes a plurality of spikes extending towards the plurality of disks.

15. The soil preparation tool of claim 9, wherein the nails are releasably retained in the disks.

16. A soil preparation tool comprising:
a handle;
a shaft having a distal end connected to the handle and a proximate end having a downward curve;
a yoke having a neck connected to the proximal end of the shaft and first and second arms extending from the neck and spaced a width from each other; and
a roller assemblage pivotally coupled to the first and second arms of the yoke, the roller assemblage having first and second rotating roller assemblies each having a plurality of disks each one of which has a plurality of radially extending tines.

17. The soil preparation tool of claim 16, wherein the roller assemblage includes a first crossbar pivotally coupled to the first arm and a second crossbar pivotally coupled to the second arm.

18. The soil preparation tool of claim 17, wherein the first crossbar has a first front axle bore and a first rear axle bore supporting a first axle of the first roller assembly, and the second crossbar has a second front axle bore and a second rear axle bore supporting a second axle of the second roller assembly.

19. The soil preparation tool of claim 16, wherein the disks are formed of injection molded plastic.

20. The soil preparation tool of claim 16, further comprising a foot bar extending between the first and second arms distal the roller assemblage.
